(19) United States
(12) Patent Application Publication
(10) Pub. No.: US 2008/0074079 A1
(43) Pub. Date: Mar. 27, 2008

(54) POWER GENERATOR AND PORTABLE DEVICE EMPLOYING SAME

(75) Inventors: SHIH-FANG WONG, Tu-Cheng (TW); CHUNG-JEN WANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/858,915

(22) Filed: Sep. 21, 2007

(30) Foreign Application Priority Data
Sep. 22, 2006 (CN) 200610062736.7

(51) Int. Cl. H02J 7/14

(52) U.S. Cl. 320/114; 320/166; 322/1

(57) ABSTRACT

A power generator (2) for supplying power to a portable device (1), the power generator includes a supporting ring (5) and is secured inside of the portable device. The supporting ring is an annular tube containing an eccentric ring (7). One or more magnet balls (8) are secured on the eccentric ring and make the center of gravity (10) of the eccentric ring not collinear with the center axis (9) of the eccentric ring. One or more wire coils (11) wrap around the supporting ring and produce electric power when the magnet balls rotates inside of the supporting ring. The electric power are then conducted to and stored in an energy storage (15). A portable device with such a built-in power generator is also provided.

### BACKGROUND

1. Technical Field

The present invention relates to a power generator and portable device employing same.

2. Related Art

Nowadays, portable devices play important roles in people's daily life. For example, mobile phones allow people to communicate from almost anywhere and anytime and bring great conveniences to people. MP3 players and MP4 players allow people to almost continuously enjoy music and bring fun to people. The portable devices commonly rely on chargeable batteries to supply power, and the rechargeable batteries typically have limited power capacity and needs to be recharged.

Generally, chargers are employed to charge the rechargeable batteries of the portable devices. The chargers receive power from AC source and convert the power into voltages suitable for the chargeable batteries. However those chargers are useless if the AC source is unavailable.

Many Power generators which convert either vibrational energy, wind energy, or solar energy into electric power have been brought into use. Those power generators can be substituted as auxiliary and “for emergency” chargers to charge the chargeable batteries when the AC source is unavailable. However, Those already-in-use power generators generally are cumbersome, thus, are unsuitable for some portable devices such as mini MP3 players and MP4 players.

Therefore, there is a need for providing a power generator with a simple structure suitable for being configured in portable device and providing electric power to the portable device.

### SUMMARY

A power generator for supply electric power to a portable device is provided in accordance with preferred embodiments of the present invention. The power generator includes a supporting ring fastened inside the portable device. The supporting ring is an annular tube and contains an eccentric ring. One or more magnetic balls are fastened on the eccentric ring and make a center of gravity of the eccentric ring not collinear with a center axis of the eccentric ring. One or more wire coils wrap around the supporting ring and produce the electric power therein when the magnetic balls rotates inside of the supporting ring. The electric power are then conducted to and stored in an energy storage.

A portable device with a built-in power generator is also provided. The power generator produces electric power and supplies the electric power to a power supply circuit of the portable device. The power supply circuit further distributes the electric power to components of the portable device. The power generator includes a supporting ring. The supporting ring is an annular tube and contains an eccentric ring. One or more magnetic balls are fastened on the eccentric ring and make a center of gravity of the eccentric ring not collinear with a center axis of the eccentric ring. One or more wire coils wrap around the supporting ring and produce the electric power inside when the magnetic balls rotates inside of the supporting ring. The electric power are conducted to and stored in an energy storage. The energy storage then supplies the electric power to the power supply circuit when needed.

Other advantages and novel features will be drawn from the following detailed description with reference to the attached drawings.

### BRIEF DESCRIPTION OF THE DRAWINGS

FIG. 1 is a block diagram of a portable electronic device with a built-in power generator;

FIG. 2 shows a schematic diagram of the power generator of FIG. 1 in accordance with a first preferred embodiment of the present invention; and

FIG. 3 shows a schematic diagram of the power generator of FIG. 1 in accordance with a second preferred embodiment of the present invention.

### DETAILED DESCRIPTION OF THE EMBODIMENTS

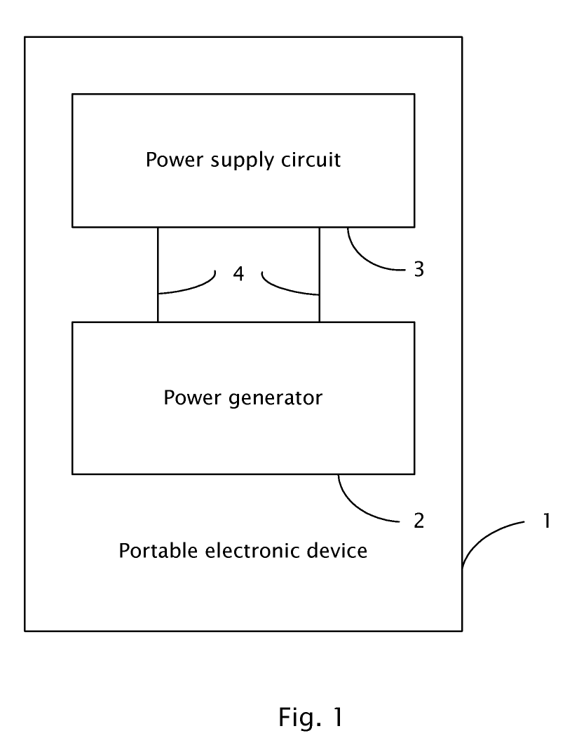

FIG. 1 is a block diagram of a portable device 1 with a built-in power generator 2. The power generator 2 generates electric power and supplies the electric power to a power supply circuit 3 of the portable device 1, thus to be used as an auxiliary and “for emergency” power source of the portable device 1. The power supply circuit 3 further distributes the electric power to components of the portable device 1.

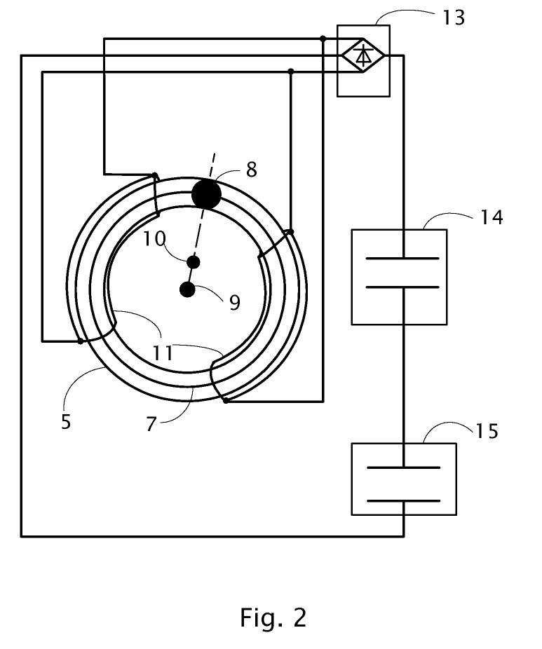

FIG. 2 is a schematic diagram of the power generator 2 in accordance with a first preferred embodiment. The power generator 2 in the first embodiment includes a supporting ring 5 fixed inside the portable device 1. The supporting ring 5 is an annular tube with an eccentric ring 7 inside of the annular tube. The eccentric ring 7 rotates inside of the supporting ring 5 when the power generator 2 is shaken with the portable device 1. The eccentric ring 7 has a center axis 9 superimposed with that of the supporting ring 5. However, in an alternative embodiment, the eccentric ring 7 may have a center axis 9 not collinear with that of the supporting ring 7. A magnetic ball 8 is fastened on the eccentric ring 7 with a weight that makes a center of gravity 10 of the eccentric ring 7 not collinear with the center axis 9 of the eccentric ring 7.

One or more wire coils 11 wrap around the supporting ring 5. In FIG. 2 two wire coils 11 are employed. Electric power is produced in the wire coils 11 when the magnetic ball 8 in the supporting ring 5 rotates and passes through the wire coils 11. The electric power is then rectified by a rectifier 13 and filtered by a filter 14, yielding smooth DC power to an energy storage 15. The rectifier 13 may be a full-bridge rectification circuit and the filter 14 may be constituted by a capacitor. The energy storage 15 conserves the DC power and supplies the DC power to the power supply circuit 3 when needed. For example, the energy storage 15 is connected to a charging circuit (not shown) for charging a secondary battery (not shown) included in the portable device 1. Two detecting circuits (not shown) are employed. One is to detect an amount of charges in the energy storage 15 and the other is to detect a battery level. If the amount of charges in the energy storage 15 reaches a predefined high level and the battery level reaches a predefined low level, an electronic switch (not shown) is turned on and enables the energy storage 15 to charge the secondary battery. In the preferred embodiments, the energy storage 15 is constituted by a large bulk capacitor.

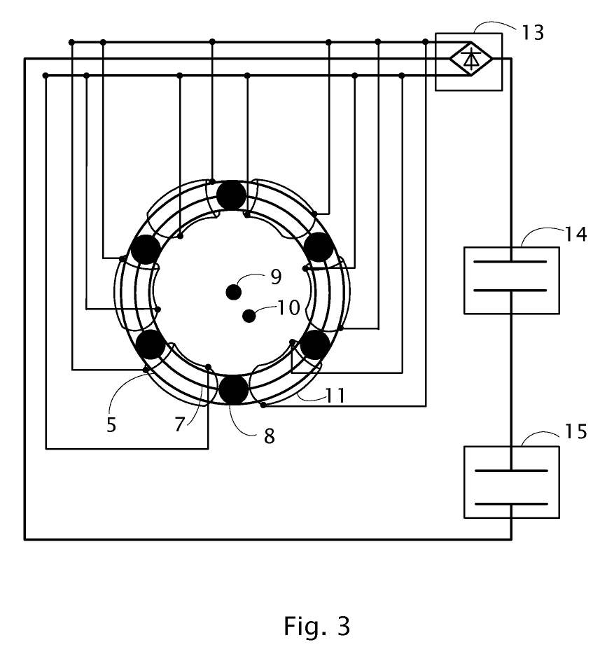

FIG. 3 is a schematic view of the power generator 2 in accordance with a second embodiment. The power generator 2 in the second embodiment has more than one magnetic balls 8 fastened on the eccentric ring 7. The more than one magnetic balls 8 are orderly or randomly arranged along the eccentric ring 7. The center of gravity 10 of the eccentric ring 7 is not collinear with its center axis 9. One or more wire coils 11 wrap around the supporting ring 5. In FIG. 3 six wire coils 11 are employed. Electric power is produced in the wire coils 11 and is conducted to the rectifier 13 and the filter 14 when the magnetic balls 8 rotate inside of the supporting ring 5 and pass through the wire coils 11.

When compared with conventional power generators, the power generator 2 has a simple structure which is characterized by the supporting ring 5 with the wire coils wrapped on and the eccentric ring 7 with magnetic balls fixed on. Further, formed to be a ring shape, the power generator 2 is particularly suitable for being configured in square-like or rectangle-like shaped portable devices.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A power generator for generating and supplying electric power to a portable device, the power generator comprising:
a supporting ring fixed inside the portable device, the supporting ring being an annular tube;
an eccentric ring with one or more magnetic balls fastened thereon, the eccentric ring being placed inside of the supporting ring and having a center of gravity which is not collinear with a center axis of the eccentric ring, the eccentric ring rotating inside of the supporting ring when the power generator is shaken;
one or more wire coils wrap around the supporting ring and generating the electric power when the eccentric ring rotates inside of the supporting ring; and
an energy storage connected with the wire coils and configured for storing the electric power and supplying the electric power to the portable device when needed.

2. The power generator as claimed in claim 1, wherein the electric power are rectified and filtered before conducted to the energy storage.

3. The power generator as claimed in claim 1, wherein the energy storage is constituted by a capacitor.

4. A portable device comprising a power generator and a power supply circuit, the power generator generating electric power and supplying the electric power to the power supply circuit, and the power supply circuit further distributing the electric power to components of the portable device, wherein:
the power generator comprises:
a supporting ring fixed inside the portable device, the supporting ring being an annular tube;
an eccentric ring with one or more magnetic balls fastened thereon, the eccentric ring being placed inside of the supporting ring and having a center of gravity which is not collinear with a center axis of the eccentric ring, the eccentric ring rotating inside of the supporting ring when the portable device is shaken;
one or more wire coils wrap around the supporting ring and producing the electric power when the eccentric ring rotates inside of the supporting ring; and
an energy storage connected with the wire coils and configured for storing the electric power and supplying the electric power to the power supply circuit when needed.

5. The portable device as claimed in claim 4, wherein the electric power are rectified and filtered before conducted to the energy storage.

6. The portable device as claimed in claim 4, wherein the energy storage is constituted by a capacitor.
